(19) United States
(12) Patent Application Publication
(10) Pub. No.: US 2010/0296880 A1
(43) Pub. Date: Nov. 25, 2010

(54) PNEUMATIC MATERIAL CONVEYING SYSTEM

(76) Inventor: Göran Sundholm, Tuusula (FI)

Correspondence Address: BIRCH STEWART KOLASCH & BIRCH, PO BOX 747, FALLS CHURCH, VA, 22040-0747, US

(21) Appl. No.: 12/809,372

(22) PCT Filed: Dec. 18, 2004
(86) PCT No.: PCT/FI08/50764

§ 371 Date: Jun. 18, 2010

(30) Foreign Application Priority Data
Dec. 21, 2007 (FI) 20075950
Dec. 21, 2007 (FI) 20075951

(51) Int. Cl. B65G 53/34; B65G 53/60

(52) U.S. Cl. 406/48; 406/93; 406/168

(57) ABSTRACT

A pneumatic material conveying system, particularly a waste conveying system, which conveying system comprises at least one feed point (61, 66) of material, particularly of waste material, a material conveying pipe (100, 101, 102) which is connectable to the feed point (61, 66), a separator device (20) in which the material being conveyed is separated from conveying air, and means (3, 4) for providing a pressure difference in the conveying pipe (100, 101, 102) at least during the conveyance of the material. At least a part of the conveying pipe (100) and conveying air channels (105, 106) is formed as at least one circuit in which the suction side of at least one vacuum generator (3) is connected, and the system comprises at least one blower device (4) the suction side of which is connected to the air channel (105, 106) coming from the separator device (20) of the circuit and the blowing side to the conveying pipe (100) or a section of the circuit in connection with the conveying pipe so that it is possible to circulate air with the blower device (4) in said circuit.

### BACKGROUND OF INVENTION

The invention relates to a pneumatic material conveying system according to the preamble of claim 1, particularly a waste conveying system, which conveying system comprises at least one feed point of material, particularly of waste material, a material conveying pipe which is connectable to the feed point, a separator device in which the material being conveyed is separated from conveying air, and means for providing a pressure difference in the conveying pipe at least during the conveyance of the material.

The invention relates generally to pneumatic conveying systems, such as vacuum conveying systems, particularly to collecting and conveying waste, such as conveying household waste.

Systems are known in which waste is conveyed in a piping by means of suction. In these, waste is conveyed for long distances in the piping by suction. Apparatuses are utilised, inter alia, for conveying waste in different institutions. Typical for them is that a vacuum apparatus is used for achieving a pressure difference, in which apparatus underpressure in the conveying pipe is provided with vacuum generators, such as vacuum pumps or an ejector apparatus. In the conveying pipe, there is typically at least one valve element by opening and closing of which make-up air coming in the conveying pipe is regulated. The vacuum conveying systems typically contain, inter alia, the following problems: high energy consumption, high air flow in the piping, problems with noise, dust and fine particles in the outlet pipe.

An object of this invention is to achieve a totally novel arrangement into connection with material conveying systems by means of which the disadvantages of known arrangements are avoided. Another object of the invention is to provide an arrangement applicable for vacuum conveying systems by means of which the volume of problematic outlet air can be decreased.

### BRIEF DESCRIPTION OF INVENTION

The invention is based on an idea in accordance with which the vacuum conveying system employs, in addition to suction, a pressure system which blows and thus intensifies the conveyance of material in the conveying piping. Furthermore, the system comprises a circuit, a section of which is formed by at least a part of the conveying pipe, in which typically the main part of air circulates in the system from the pressure side to the suction side and only part of conveying air is led out of the system.

The material conveying system according to the invention is mainly characterised in that at least a part of the conveying pipe and conveying air channels is formed as at least one circuit in which the suction side of at least one vacuum generator is connected, and that the system comprises at least one blower device the suction side of which is connected to an air channel coming from the separator device of the circuit and the blowing side to the conveying pipe or a section of the circuit in connection with the conveying pipe so that it is possible to circulate air with the blower device in said circuit.

Furthermore, the material conveying system according to the invention is characterised by what is stated in claims 2-18.

The arrangement according to the invention has numerous significant advantages. By arranging the piping of the system to comprise a circuit where at least part of conveying air circulates, the volume of outlet air can be decreased. At the same time, the energy consumption of the system is minimised. By maintaining underpressure and simultaneously blowing, it is possible to provide an effective circulation of conveying air in the circuit and conveyance of material in the conveying pipe. With the arrangement according to the invention, it is possible to decrease the volume of outlet air substantially and simultaneously to decrease possible problems with dust and fine particles in the outlet pipe. The arrangement according to the invention also substantially decreases the noise problem caused by prior art. Moisture accumulated in the piping is minimised and the piping can be dried by circulating air in the piping. As the volume of air being sucked inside decreases, also energy consumption decreases.

### BRIEF DESCRIPTION OF FIGURES

In the following, the invention will be described in detail by means of an example with reference to the accompanying drawings in which

FIG. 1 schematically shows a system according to an embodiment of the invention,

FIG. 2 schematically shows a system according to a second embodiment of the invention,

FIG. 3 schematically shows a system according to a third embodiment of the invention,

FIG. 4 schematically shows a system according to a fourth embodiment of the invention,

FIG. 5 schematically shows a system according to a fifth embodiment of the invention,

FIG. 6 schematically shows a further system according to the invention,

FIG. 7 schematically shows a further embodiment of a system according to the invention, and

FIG. 8 schematically shows another embodiment of the invention.

### DETAILED DESCRIPTION OF INVENTION

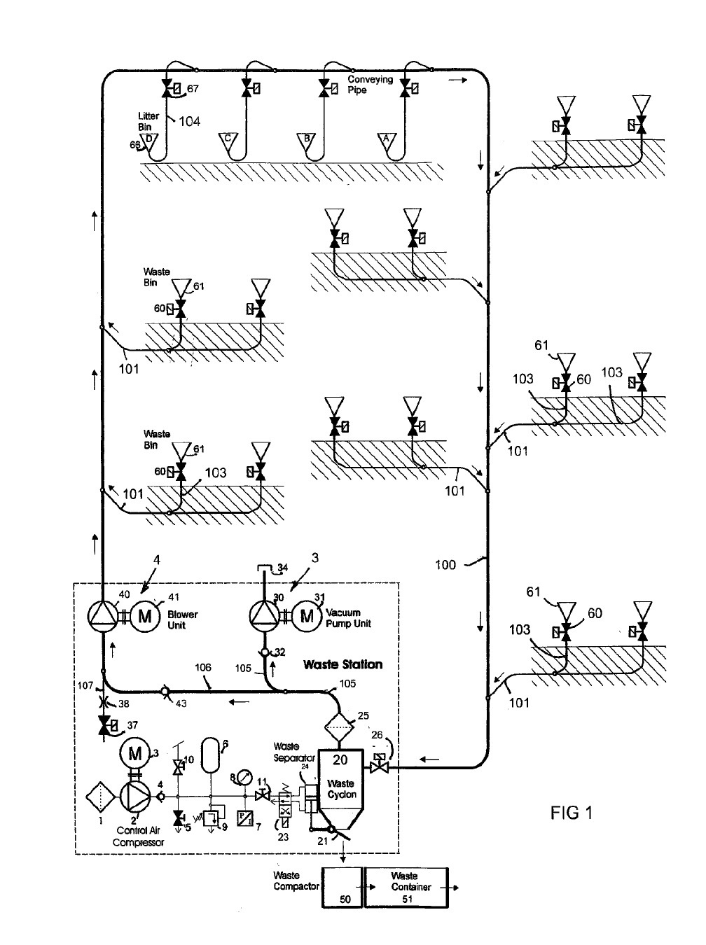

FIG. 1 schematically shows an embodiment of a system according to the invention. The figure schematically shows a material conveying system, particularly a waste material conveying system.

In FIG. 1, reference number 61, 66 designates a feed station of materials, particularly of waste material, intended to be conveyed, from which station material, particularly waste material, such as household waste, intended to be conveyed is fed to the conveying system. The system can comprise several feed stations 61, 66 from which the material intended to be conveyed is fed to a conveying piping 100, 101, 103, 104. Typically, the conveying piping comprises a main conveying pipe 100 into which several branch conveying pipes 101 can have been connected and into which again several feed stations 61, 66 can have been connected via feed pipes 103, 104. The fed material is conveyed along the conveying piping 100, 101, 103, 104 to a separator device 20 in which the material being conveyed is separated, e.g. due to centrifugal force, from conveying air. The separated material is removed, e.g. when required, from the separator device 20 to a material container, such as a waste container 51, or to further treatment. The material container can comprise, as in the embodiment of the figures, a waste compactor 50 from which the material is further conveyed to the waste container 51. In the embodiment of FIG. 1, the separator device 20 is provided with material outlet elements 21, 24. From the separating device 20, a pipe 105 leads to means 3 for generating underpressure in the conveying pipe. In the embodiment of FIG. 1, the means for generating underpressure comprise a vacuum pump unit 3. With the means for generating underpressure, underpressure required for conveying the material is provided in the conveying piping 100, 101, 103, 104. The vacuum pump unit 3 comprises a pump 30 which is operated by an actuator 31.

According to the invention, the system further comprises a blower unit 4 which is connected in the embodiment of the figure from the blowing side to the conveying pipe 100. The conveying pipe 100 is a section of a circuit which in the embodiment of the figure consists of the main conveying pipe 100, the separator element 20 and the pipes 105 and 106. The blower unit 4 comprises a blower 40 and its actuator 41. The blower 40 of the blower unit 4 is arranged from the suction side to the pipe 105, 106 coming from the separating device 20. The conveying pipe 100 is thus connected to the blower 40 on its blowing side.

In the embodiment according to FIG. 1, into the main conveying pipe 100 are connected several branch conveying pipes 101. In the figure, into each branch conveying pipe 101 are connected two feed stations 61 via the feed pipes 103.

In the upper part of the figure, there are further three feed stations 66 connected directly to the main conveying pipe 100 via the feed pipes 104.

The sum of suctions provided by the vacuum unit 3 and the blower unit 4 to the conveying pipe 100, in the figure from the side of the separator device 20, is advantageously greater than the blowing provided by the blower unit 4. With the blower 40, it is typically possible to provide pressure which is e.g. in the range of 0.1-0.5 bar. With the vacuum generators, it is again typically possible to provide underpressure which is e.g. in the range of 0.1-0.5 bar.

The suction being greater than the blowing, which is the target in the system according to the invention, material fed to the conveying pipe 100, particularly waste material, will not be compressed and compacted, but will be able to travel “freely” in the pipe 100 conveyed by conveying air. Then, the potential of the material being conveyed to form blockages is considerably lower than in a situation in which the blowing is greater than the suction, whereby there is a risk that the material being conveyed will accumulate and block the conveying pipe. Furthermore, underpressure decreases the power required to convey the material, because even partial underpressure in relation to the material portion being conveyed on the side of the conveying direction considerably decreases air drag, among others. In the figure, arrows designate the direction of motion of conveying air in the piping in the operating mode.

In conveying material, such as conveying waste material, when the material of the feed point is first conveyed via the feed pipe 101, 103 or 104 to the conveying pipe 100, extremely fast acceleration and conveyance are provided for the material.

In the embodiment of the figure, in the pipe 106 on the suction side of the blower 40 is formed a fitting 107 in which there is a valve 37 by opening of which extra air can be brought on the suction side of the blower from outside the circuit. By opening the valve 37, it is possible to raise the rate of air in the conveying pipe if required and to provide an increased conveying rate for conveying the material. The suction pipe 107 can be provided with a choke element 38.

To the feed pipes 103, 104 is arranged the outlet valve 60, 67 which is opened and closed so that material portions of suitable size are conveyed from the feed point 61, 66 to the branch conveying pipe 101, 102 or directly to the main conveying pipe 100. Material is fed from the feed point 61, 66, such as a waste container, when after the container is full, the outlet valve 60, 67 is opened either automatically or manually.

The system typically operates as follows: An outlet hatch 21 of the separator device 20 is closed and a valve 26 between the main conveying pipe 100 and the separator device 20 is open. The vacuum pump unit 3 and/or the blower unit 4 maintain underpressure in the main conveying pipe 100. A suction effect provided by the vacuum unit 3 and the blower unit 4 together via the separator device 20 to the conveying pipe 100 is greater than a pressure effect provided by the blower unit 4 to the conveying pipe 100 at its one end.

All outlet valves 60, 67 in the vicinity of the feed points i.e. waste containers are closed.

Let us assume that a waste container of the feed point 61 belonging to the area of the first branch conveying pipe 101 is to be emptied. Based on an emptying signal, the outlet valve 60 is momentarily opened, e.g. for 2-10 seconds, whereby the material being conveyed, such as waste material, conveys from the effect of underpressure to the branch conveying pipe and further to the main conveying pipe 100. The outlet valve 60 is typically closed after a few seconds after the start situation. The vacuum pump unit 3 maintains desired underpressure and the blower unit 4 starts unless not already running. The valve 69 is opened, whereby in the piping is provided blowing i.e. an intensified pressure effect and suction effect which conveys the material portion being conveyed along the piping to the separator device 20.

When the separator device 20 is full, the valve 26 of the conveying pipe 100 closes and a control valve 23 opens, whereby the actuator 24 of the outlet hatch 21 of the separator device opens the outlet hatch 21 and the material accumulated in the separator device is emptied in the compactor device 50 and further in the waste container 51. The outlet hatch 21 of the separator device 20 is closed and the valve 26 opened.

After this, the start situation is reverted and the emptying process can be repeated or the emptying of some other feed point/feed points can be implemented.

The waste container 51, such as a waste freight container, is replaced or emptied when it is full.

In waste conveyance, it is possible to optimise air circulation and blowing so that the blowing is always directed as close as possible to the material portion being conveyed, whereby the blowing effect directs at the material portion being conveyed as close as possible and the motion of the material portion can be best maintained in the conveying pipe.

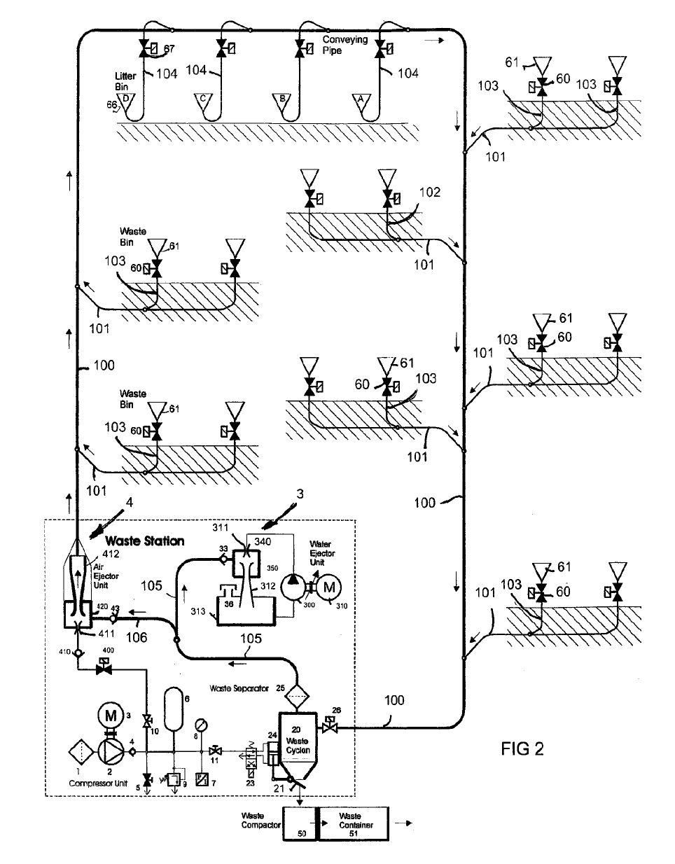

FIG. 2 shows a second embodiment of the invention in which as the vacuum generator 3 is arranged to operate an ejector device, particularly an ejector device employing water as the actuating medium. Typically, the ejector device employs aqueous liquid as the actuating medium which is pumped by a pump device 300 to an ejector nozzle 311 which sprays the actuating medium in an ejector pipe 312 and provides suction in the pipe 105 which is connected to the separator device or the pipe coming from it. By using water mist as the actuating medium of the ejector device, on the one hand is provided an effective suction effect (underpressure) and particles and impurities and possible odours coming from the suction pipe 105 can be affected by decreasing their volume in the outlet air. In the embodiment according to the figure, the circulation of the actuating medium of the ejector device is arranged by directing the ejector pipe 312 to a container 313 from which the actuating medium is circulated to the ejector nozzle 311 for spraying. As the blower device 4 in the embodiment of FIG. 2 is arranged to be used an ejector device an ejector pipe 412 of which is arranged to blow in a circuit comprising the conveying pipe 100 or at least its section. The suction side of the ejector device is connected to the separator device 20 or the pipe 106 coming from it. The actuating medium of this ejector device is gas, most suitably compressed air. The compressed air required by the ejector unit is produced by a compressor unit which comprises a pump device 2 and its actuator 3. The compressor unit can also comprise a pressure container 6 known as such. From the compressor unit, there is an actuating medium passage, which is in the embodiment of the figure provided with a valve element 400, to an ejector nozzle 411 of the ejector unit which when activated sprays medium to the ejector pipe 412 and provides suction in the pipe 106 coming from the separator device 20. Equivalently, air coming from the separator device circulates through the ejector pipe 412 and obtains more kinetic energy and is circulated to the circuit of the conveying pipe 100. Typically, the combined suction effect of the ejector devices of the vacuum generator 3 and the blowing device 4 is greater than the blowing effect of the ejector device operating as the blowing device 4 blowing to the conveying pipe 100.

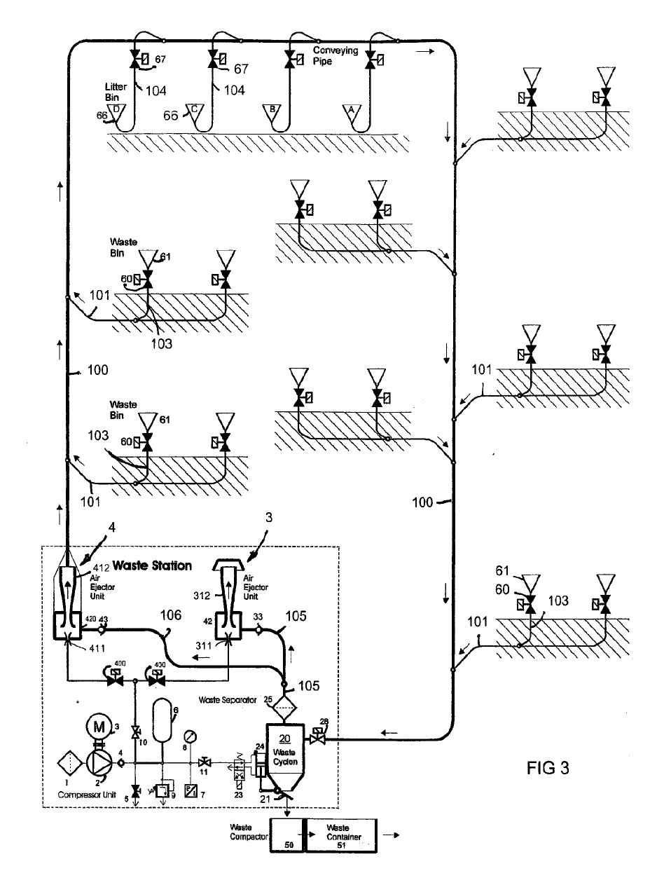

FIG. 3 shows a further embodiment in which the vacuum generator 3 is an ejector device, particularly an ejector device employing gas, particularly compressed air, as the actuating medium. Then, compressed air also required by this ejector unit is produced by the compressor unit which comprises the pump device 2 and its actuator 3. The compressor unit can also comprise the pressure container 6 known as such. From the compressor unit, there is an actuating medium passage to the ejector nozzle 311 of the ejector unit which when activated sprays medium to the ejector pipe 312 and provides suction in the pipe 105 coming from the separator device 20. In a channel passing from a pneumatic source to the ejector nozzle 311 is arranged the valve element 400 by controlling which the operation of the ejector unit can be controlled. Equivalently, also the second ejector unit utilised as the blower device 4 can be controlled by opening and closing the equivalent valve.

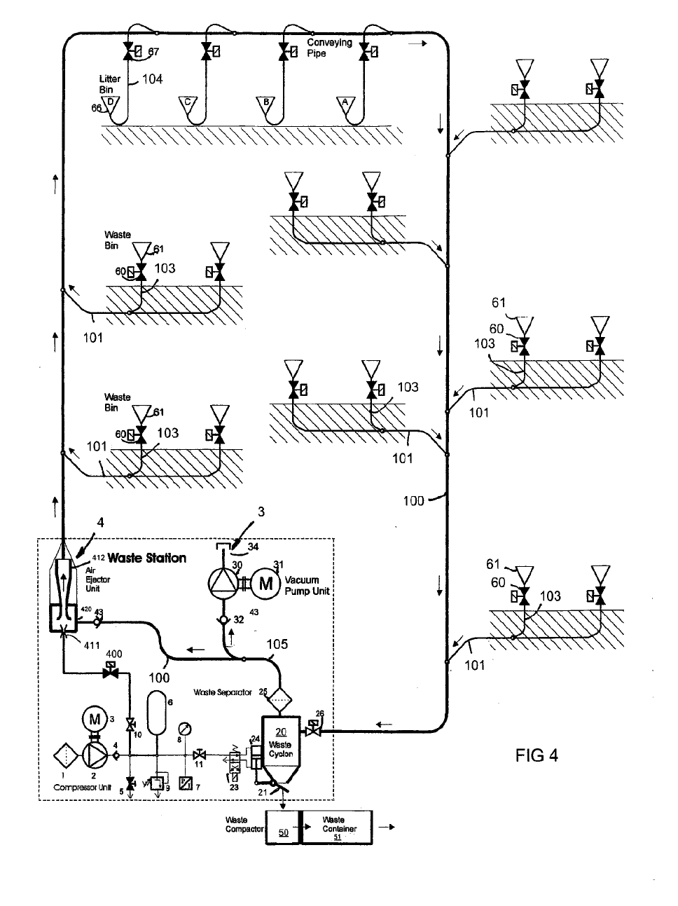

FIG. 4 additionally shows the embodiment in which the vacuum pump 30 operated by the actuator 31 is utilised as the vacuum generator 3. The suction side of the vacuum pump is connected to the pipe 105 coming from the separator device 20 and it blows outlet air to an outlet opening 34.

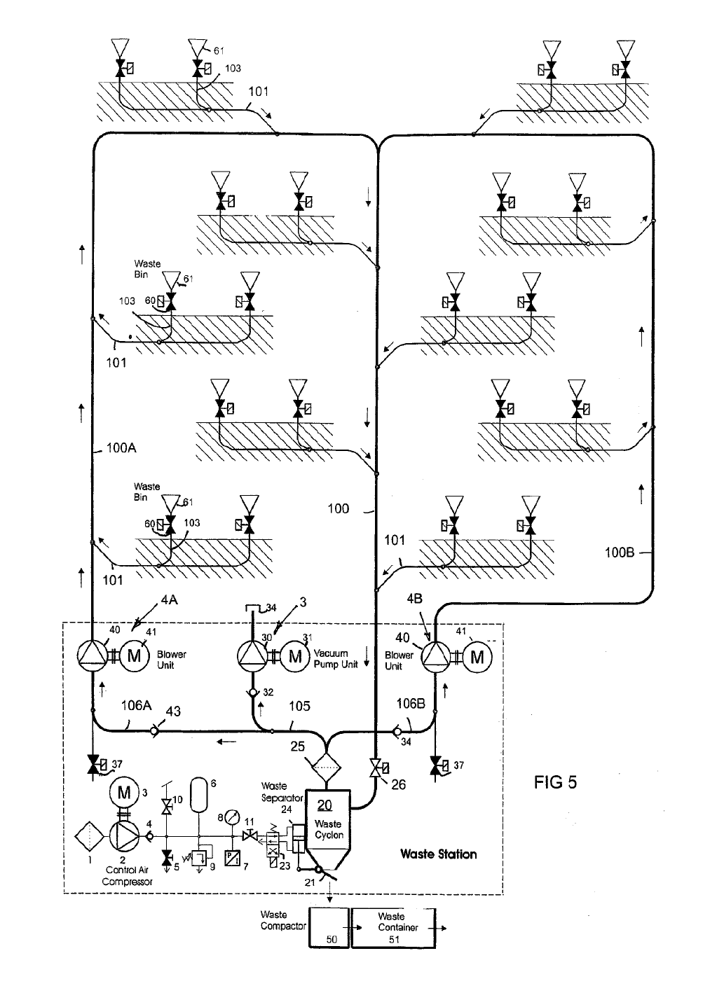

FIG. 5 shows an embodiment in which the system comprises two circuits, an outlet pipe of which starting from the separator device braches into two conveying pipes 100A, 100B in which are arranged their own blowers 4A, 4B and which conveying pipes 100A, 100B are combined as the pipe 100 going to the separator device 20.

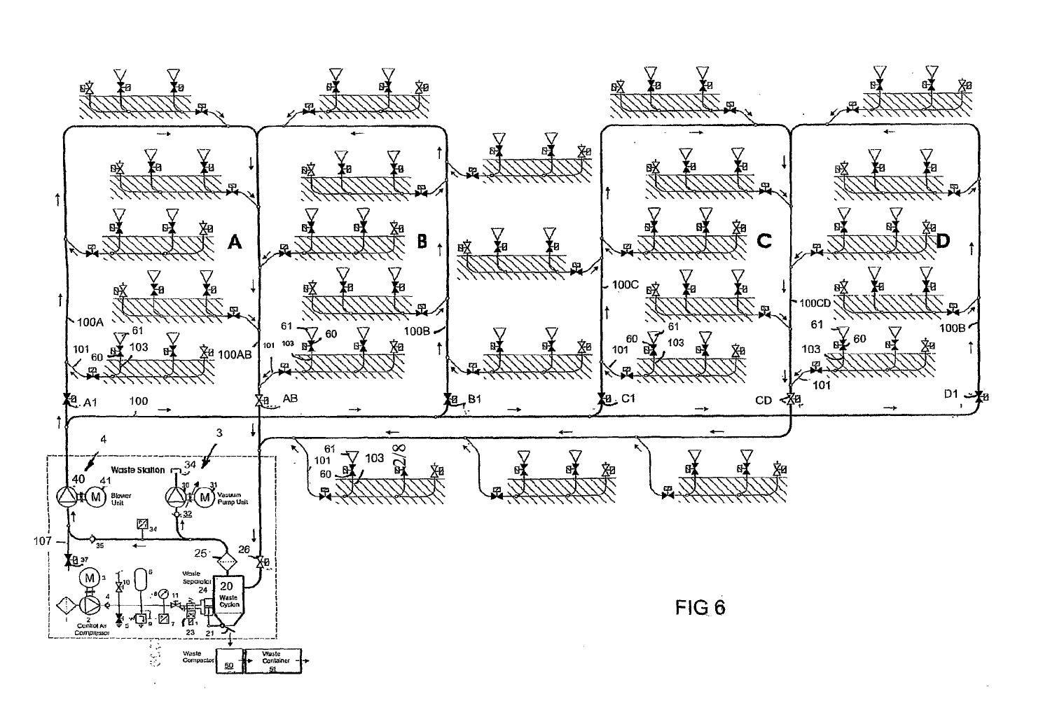

The embodiment according to FIG. 6 schematically shows a more extensive system which comprises several partial circuits A, B, C, D. The system can comprise several circuits the air circulation of which is controllable by means of valve elements A1, B1, C1, D1, AB, CD arranged in pipings 100A, 100B, 100C, 100D, 100AB, 100CD of the partial circuits A, B, C, D. Then, part of the circuits can be out of air circulation and the air circulation is only controlled to those one or more circuits of the system from which the material is conveyed. The system comprises a pipe network which includes four partial circuits A, B, C and D. Each partial circuit contains the pipelines 100A, 100B, 100C, 100D which are in the circulation direction of conveying air connectable from the inlet side to the pipeline 100 coming from the blower device 4 by opening and closing the valve elements A1, B1, C1, D1. In the embodiment of the figure, the conveying pipes 100A, 100B of the circuits A and B are combined as the conveying pipe 100AB which leads to the separator device 20. Equivalently, the conveying pipes 100C, 100D of the circuits C, D are combined as the conveying pipe 100CD which leads to the separator device 20. In the example of the figure, arrows designate the circulation of conveying air in the circuits in a situation in which the circuits are connected active. Equivalently, the material being conveyed travels in the direction of the arrows to the separator device from one of the material feed points arranged along the circuits.

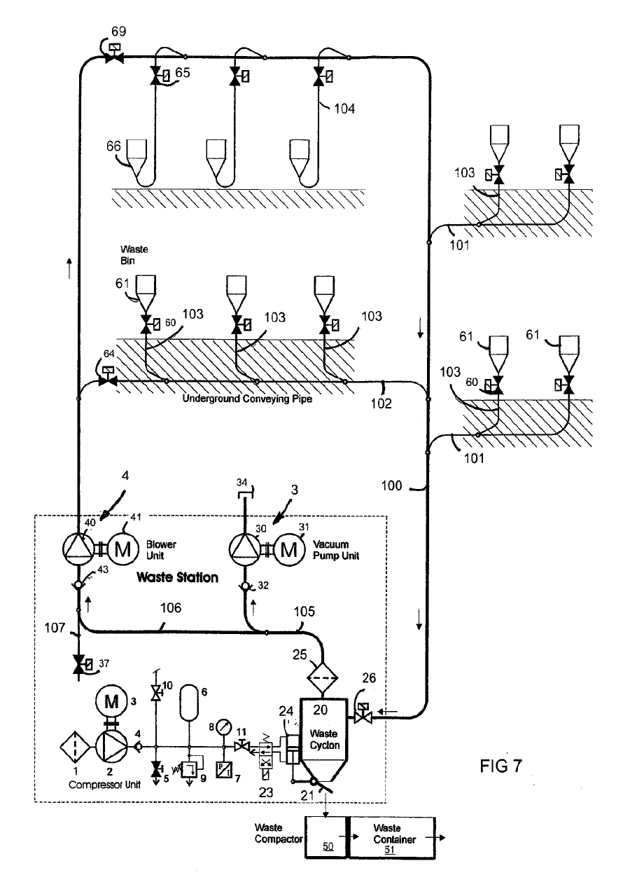

In the embodiment according to FIG. 7, in the main conveying pipe is arranged at least one valve element 69 typically between the blower 40 of the blower unit 4 and the feed pipes 103 and/or branch conveying pipes 101, 102 in the blowing direction of the blower 40. The blower also generates underpressure together with the vacuum generator.

The valve element 64 and 69 being in the closed position, the blower 40 raises pressure to a section between the blower and the valve element 69 in the conveying pipe 100. Equivalently in a section of the circuit on the suction side of the vacuum generator 3 and/or the blower 40, when travelling against the conveying direction and/or the air flow direction, which comprises in the embodiment of the figure the pipes 105, 106, the separator device 20 and a section of the main conveying pipe 100 from the separating device as far as the valves 69, underpressure prevails when the valves 69, 64 and the valves 60, 65 of the feed stations 61, 66 to the conveying pipe are closed.

In the embodiment of FIG. 7, the branch conveying pipe 102 extends from the pressure side of the main conveying pipe 100 to the suction side of the main conveying pipe i.e. forms a section of a smaller circuit. In the branch conveying pipe 102, at its end on the side of the pressure side of the main conveying pipe, is arranged the valve 64. The valve 64 of the branch conveying pipe being open and the valve 69 of the main conveying pipe being closed, a smaller circuit is formed in the embodiment of the figure in which air circulates from the blower 40 from the pressure side of the main conveying pipe via the branch conveying pipe 102 to the suction side of the main conveying pipe and further via the separator device to the pipe 105 and 106. When the vacuum pump unit runs, part of air circulating in the circuit is led to an outlet 34.

In the embodiment according to FIG. 7, into the main conveying pipe 100 are connected two first branch conveying pipes 101. In the figure, into both first branch conveying pipes 101 are connected two feed stations 61. Into the second branch conveying pipe 102 are connected three feed stations 61 by means of feed pipes 103. However, there can be more of them, e.g. 20. They can be opened and the material conveyed to the conveying pipe stepwise, first the one closest in relation to the separator element, then the next closest etc.

In the upper part of the figure, there are further three feed stations 66 connected directly to the main conveying pipe via feed pipes 104.

The sum of suctions provided by the vacuum unit 3 and the blower unit 4 to the conveying pipe 100, in the figure from the side of the separator element, is advantageously greater than the blowing provided by the blower unit, whereby conveyance takes place in underpressure. With the blower 40, it is typically possible to provide pressure which is e.g. in the range of 0.1-0.5 bar. With the vacuum generators, it is again typically possible to provide underpressure which is e.g. in the range of 0.1-0.5 bar. The blowing stores energy (i.e. overpressure) in the section of the conveying pipe 100 between the blower 40 and the valve 69 (and the valve 64) along with the rise of pressure, when the valves 69, 64 are closed, e.g. +0.5 bar. The suction of the vacuum units 3 stores on the other side i.e. to the section of the valve 69 and the separator element 20 (and the pipe 105) underpressure which is e.g. −0.5 bar. When at least one of the valves 69, 64 opens, the pressure difference can then be even 1 bar. The suction being greater than blowing, underpressure is provided in the piping, whereby waste can be sucked inside the piping from a funnel of the feed station 61.

The suction being greater than the blowing, which is the target in the system according to the invention, material fed to the conveying pipe, particularly waste material, will not be compressed and compacted, but will be able to travel “freely” in the pipe conveyed by conveying air. Then, the potential of the material being conveyed to form blockages is considerably lower than in a situation in which the blowing is greater than the suction, whereby there is a risk that the material being conveyed will accumulate and block the conveying pipe. Furthermore, underpressure decreases the power required to convey the material, because even partial underpressure in relation to the material portion being conveyed on the side of the conveying direction considerably decreases air drag, among others. In the figure, arrows designate the direction of motion of air in the piping in the operating mode.

In conveying material, such as conveying waste material, when the material of the feed point is first conveyed by suction via the feed pipe 101, 103 or 104 to the conveying pipe, extremely fast acceleration and conveyance are provided for the material.

The conveying power provided by the pressure difference can then be e.g. in a pipe of a diameter of 400 mm about in the range of 12.32 kN (1,256 kp). The pressure side of the conveying pipe 100, i.e. in the example of the figure the section between the blower 40 and the valve 69, 64, can be substantially smaller of its diameter than the suction side of the conveying pipe, i.e. typically at least the section between the valve 69, 64 and the separator element 20. The pressure side can then be formed more advantageous of its diameter and costs.

In the embodiment of the figure, in the pipe 106 on the suction side of the blower is formed a fitting 107 in which there is a valve 37 by opening of which extra air can be brought on the suction side of the blower 4 from outside the circuit. By opening the valve 37, it is possible to raise the pressure of air in the conveying pipe if required and to provide an increased conveying rate for conveying the material.

To the feed pipes 103, 104 is arranged the outlet valve 60, 65 which is opened and closed so that material portions of suitable size are conveyed from the feed point 61, 66 to the branch conveying pipe 101, 102 or directly to the main conveying pipe 100. Material is fed from the feed point 61, 66, such as a waste container, when after the container is full, the outlet valve 60, 65 is opened either automatically or manually.

The system typically operates as follows: An outlet hatch 21 of the separator device 20 is closed and a valve 26 between the main conveying pipe 100 and the separator device 20 is open. The vacuum pump unit 3 and/or the blower unit 4 maintain underpressure in the main conveying pipe 100. A suction effect provided by the vacuum unit 3 and the blower unit 4 together via the separator device 20 to the conveying pipe 100 is greater than a pressure effect provided by the blower unit 4 to the conveying pipe 100 at its one end i.e. to the blowing side, to the section between the blower 40 and the valve 69 or the valve 64.

All outlet valves 60, 65 in the vicinity of the feed points i.e. waste containers are closed. In the start situation, the area valve 64 of the branch conveying pipe 102 and the line valve 69 of the main conveying pipe 100 are closed.

Let us assume that a waste container of the feed point 61 belonging to the area of the first branch conveying pipe 101 is to be emptied. Based on an emptying signal, the outlet valve 60 is momentarily opened, e.g. for 2-10 seconds, whereby the material being conveyed, such as waste material, conveys from the effect of underpressure to the branch conveying pipe and further to the main conveying pipe 100. The outlet valve 60 is typically closed after a few seconds after the start situation. The vacuum pump unit 3 maintains desired underpressure and the blower unit 4 starts unless not already running. The valve 69 is opened, whereby in the piping is provided blowing i.e. an intensified pressure effect and suction effect which conveys the material portion being conveyed along the piping to the separator device 20.

When the separator device 20 is full, the valve 26 of the conveying pipe 100 closes and a control valve 23 opens, whereby the actuator 24 of the outlet hatch 21 of the separator device opens the outlet hatch 21 and the material accumulated in the separator device is emptied in the compactor device 50 and further in the waste container 51. The outlet hatch 21 of the separator device 20 is closed and the valve 26 opened.

After this, the start situation is reverted and the emptying process can be repeated or the emptying of some other feed point/feed points can be implemented.

The waste container 51, such as a waste freight container, is replaced or emptied when it is full.

In waste conveyance, it is possible to optimise air circulation and blowing so that the blowing is always directed as close as possible to the material portion being conveyed. If a material portion fed directly via the feed point 66 is being conveyed, first is opened the valve 69 in the main conveying pipe 100. After the material portion has passed the connecting point of the branch conveying pipe 102 and the main conveying pipe 100 in the case of the figure, the valve 64 of the branch conveying pipe is opened and the valve 69 of the main conveying pipe is closed, whereby the blowing effect directs at the material portion being conveyed as close as possible and the motion of the material portion can be best maintained in the conveying pipe.

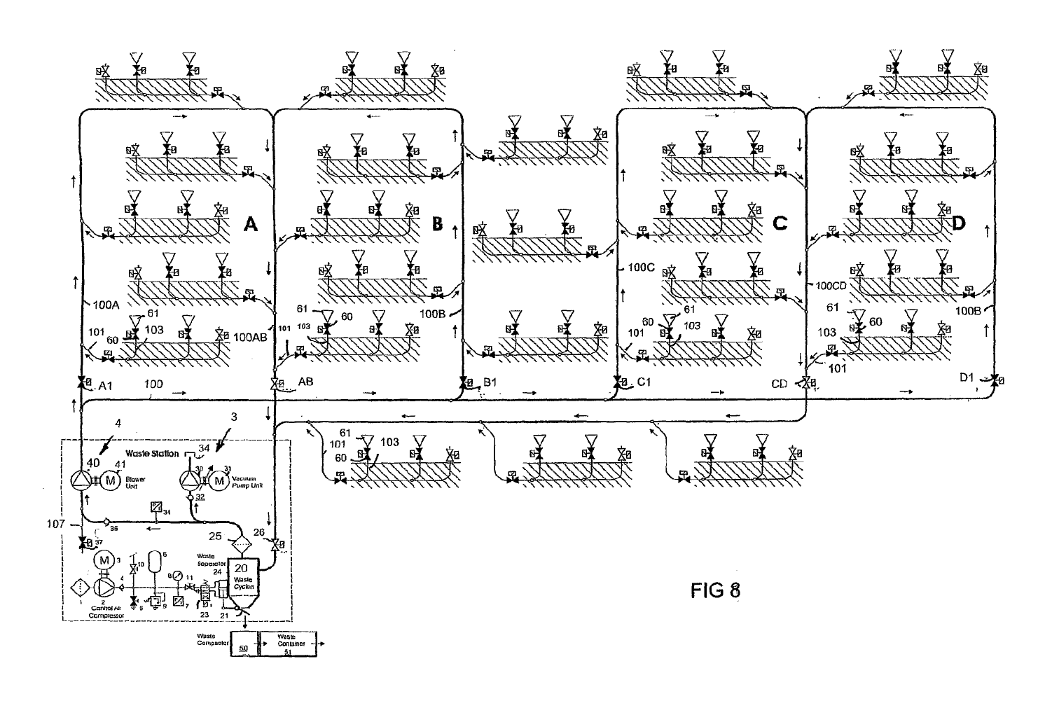

The embodiment according to FIG. 8 schematically shows a more extensive system which comprises several partial circuits A, B, C, D. The system can comprise several circuits the air circulation of which is controllable by means of valve elements A1, B1, C1, D1, AB, CD arranged in pipings 100A, 100B, 100C, 100D, 100AB, 100CD of the partial circuits A, B, C, D. Then, the valves A1, B1, C1, D1 of the blowing side are first closed. The blower raises the pressure in the pipe section between the conveying pipe or a pipe being in connection with it and the valve A1, B1, C1, D1. Equivalently in the section of the circuit on the suction side of the vacuum generator 3 and/or the blower 40, when travelling against the conveying direction and/or the air flow direction, which comprises in the embodiment of the figure the pipes 105, 106, the separator device 20 and the section of the conveying pipes 100AB, 100CD from the separator device 20 to the valves A1, B1 and equivalently as far as C1, D1, underpressure prevails when the valves A1, B1, C1, D1 and the valves 60 of the feed stations 61 are closed. Part of the circuits can be out of air circulation and the air circulation is only controlled to those one or more circuits of the system from which the material is conveyed. Typically on the underpressure side in the start situation, the valves AB and CD to the partial circuits are open, but typically the valve of the circuit to be activated is kept open and the valve of the circuit to be non-activated is closed.

The system comprises a pipe network which includes four partial circuits A, B, C and D. Each partial circuit contains the pipelines 100A, 100B, 100C, 100D which are in the circulation direction of conveying air connectable from the inlet side to the pipeline 100 coming from the blower device 4 by opening and closing the valve elements A1, B1, C1, D1. In the embodiment of the figure, the conveying pipes 100A, 100B of the circuits A and B are combined as the conveying pipe 100AB which leads to the separator device 20. Equivalently, the conveying pipes 100C, 100D of the circuits C, D are combined as the conveying pipe 100CD which leads to the separator device 20. In the example of the figure, arrows designate the circulation of conveying air in the circuits in a situation in which the circuits are connected active. Equivalently, the material being conveyed travels in the direction of the arrows to the separator device from one of the material feed points arranged along the circuits.

The invention thus relates to a pneumatic material conveying system, particularly a waste conveying system, which conveying system comprises at least one feed point 61, 66 of material, particularly of waste material, a material conveying pipe 100, 101, 102 which is connectable to the feed point 61, 66, a separator device 20 in which the material being conveyed is separated from conveying air, and means 3, 4 for providing a pressure difference in the conveying pipe 100, 101, 102 at least during the conveyance of the material. At least a part of the conveying pipe 100 and conveying air channels 105, 106 is formed as at least one circuit in which the suction side of at least one vacuum generator 3 is connected, and the system comprises at least one blower device 4 the suction side of which is connected to the air channel 105, 106 coming from the separator device 20 of the circuit and the blowing side to the conveying pipe 100 or a section of the circuit in connection with the conveying pipe so that it is possible to circulate air with the blower 4 in said circuit.

According to an advantageous embodiment, the system comprises several partial circuits A, B, C, D the conveying air circulation of which is controllable, such as openable or closable, by means of one or more area valves A1, B1, C1, D1, AB, CD arranged in the circuit.

According to another advantageous embodiment, underpressure provided by the devices 3, 4 generating underpressure of the circuit activated in the system i.e. suction in the material conveying pipe 100, 100A, 100B, 100C, 100D, 100AB, 100CD is greater than the pressure effect i.e. blowing provided by at least one blower 4.

In a typical case, the vacuum generator 3 can be a vacuum pump.

According to another advantageous embodiment, the vacuum generator 3 is an ejector pump device.

According to an advantageous embodiment of the invention, at least the main part of conveying air is circulated in the circuit. Then, the volume of outlet air can be decreased considerably. According to an embodiment of the invention, only part of conveying air is led out of the circuit.

According to an embodiment of the invention, the vacuum pump unit 3 is arranged to provide required basic underpressure in the conveying piping 100.

Typically, at least one blower device 4 is arranged to circulate conveying air in the circuit.

The vacuum generator 3 and/or the blower device 4 is arranged to intensify at least momentarily the conveying effect of material provided by at least one vacuum generator 3 and/or blower device 4 in the conveying piping 100, 101, 102.

According to an embodiment of the invention, the material conveying system is a waste conveying system. The waste conveying system can even be applicable in the waste management of extensive areas and it can be combined as a part of a larger waste system. The system can comprise several waste stations and/or there can be several separator elements and waste containers in the waste stations in which the conveyed material from the separator device is emptied. The material feed points 61, 66 are then waste feed points, such as waste bins or waste chutes.

According to an embodiment of the invention, the blower device 4 is an ejector device the outlet side of which is connected to the material conveying pipe 100 directly or by a connecting channel and which is arranged to blow in the circuit in the direction of the conveying air circulation. According to another embodiment of the invention, the blower device 4 is an ejector device the actuating medium of which is gas, particularly compressed air. According to the invention, the system can comprise several blower devices which can be arranged to blow in the inlet pipes of different partial circuits.

According to an embodiment of the invention, the vacuum generator 3 is an ejector device the actuating medium of which is water, particularly water mist.

According to another embodiment of the invention, the vacuum generator 3 is an ejector device the actuating medium of which is gas, particularly compressed air.

According to yet another embodiment of the invention, the system further comprises at least one blower 40 of the blower device 4 the suction side of which is connected to the air channel 105, 106 coming from the separator device 20 of the circuit and the blowing side to the conveying pipe 100 or a section of the circuit being in connection with or being connectable with the conveying pipe so that it is possible to circulate air with a blower 40 of the blower device 4 in said circuit, and in the circuit is arranged at least one valve element 69 between the blower 40 and at least one material feed point 61, 66. The valve divides the circuit into the pressure side and the suction side on which pressure side is providable overpressure, at least when the valve element 69 of the circuit is closed, and on the suction side underpressure. The valve 69 is arranged to open at least during the conveyance of the material.

The system can comprise several circuits the air circulation of which is controllable by means of the valve elements 69, 64 arranged in the partial circuits. Then, part of the circuits can be out of air circulation and the air circulation is only controlled to those circuits of the system from which the material is conveyed.

In the embodiment of FIG. 1, the separator element 20, which is a so-called waste cyclone, the vacuum pump devices 3, the blower unit 4 and the compressor unit 1, which drives the emptying mechanism of the separator element, are located at the delivery end of material of the material conveying system i.e. particularly in a waste conveying system into connection with a waste station.

In a case according to the invention, the conveying pipe 100 is at least a section of a suction/blowing circuit, the output end and inlet end of which are advantageously arranged into connection with the waste station and in which the output end of the suction/blowing circuit is on the blowing side of the blower 40 and the inlet end on the suction side of the blower 40. The blower can circulate air in the suction/blowing circuit a section of which is formed by the conveying pipe 100. The blower can then, the valve 69 being open, circulate air in the suction/blowing circuit of FIG. 7 a section of which is formed by the conveying pipe 100. The feed points 61, 66 can be located decentralised along the system pipings distributedly. In connection with the waste conveying system, the feed points can be e.g. waste bins or waste chutes.

It is obvious to those skilled in the art that the invention is not limited to the embodiments described above, but it may be varied within the scope of the enclosed claims. When necessary, the features possibly described in this specification together with other features may also be used separately from each other.

1. A pneumatic material conveying system, particularly a waste conveying system, which conveying system comprises at least one feed point (61, 66) of material, particularly of waste material, a material conveying pipe (100, 101, 102) which is connectable to the feed point (61, 66), a separator element (20) in which the material being conveyed is separated from conveying air, and means (3, 4) for providing a pressure difference in the conveying pipe (100, 101, 102) at least during the conveyance of the material, characterised in that at least a part of the conveying pipe (100) and conveying air channels (105, 106) is formed as at least one circuit in which the suction side of at least one vacuum generator (3) is connected, and that the system comprises at least one blower device (4) the suction side of which is connected to the air channel (105, 106) coming from the separator device (20) of the circuit and the blowing side to the conveying pipe (100) or to a section of the circuit being in connection with the conveying pipe so that it is possible to circulate air with the blower device (4) in said circuit.

2. A material conveying system according to claim 1, characterised in that the system comprises several partial circuits (A, B, C, D) the air circulation of which is controllable, such as openable or closable, by means of one or more area valves (A1, B1 C1, D1, AB, CD) arranged in the circuit.

3. A material conveying system according to claim 1, characterised in that underpressure provided by the devices (3, 4) generating underpressure of the circuit activated in the system i.e. suction in the material conveying pipe (100, 100A, 100B, 100C, 100D, 100AB, 100CD) is greater than the pressure effect i.e. blowing provided by at least one blower (4).

4. A material conveying system according to claim 1, characterised in that the vacuum generator (3) is a vacuum pump.

5. A material conveying system according to claim 1, characterised in that the vacuum generator (3) is an ejector pump device.

6. A material conveying system according to claim 1, characterised in that at least the main part of conveying air is circulated in the circuit.

7. A material conveying system according to claim 1, characterised in that only part of the conveying air is led out of the circuit.

8. A material conveying system according claim 1, characterised in that the vacuum pump unit (3) is arranged to provide basic underpressure in the conveying piping (100).

9. A material conveying system according to claim 1, characterised in that at least one blower device (4) is arranged to circulate conveying air in the circuit.

10. A material conveying system according to claim 1, characterised in that the vacuum generator (3) and/or the blower device (4) is arranged to intensify at least momentarily the conveying effect of material provided by at least one vacuum generator (3) and/or blower device (4) in the conveying piping (100, 101, 102).

11. A material conveying system according to claim 1, characterised in that the material conveying system is a waste conveying system.

12. A material conveying system according to claim 1, characterised in that the material feed points (61, 66) are waste feed points, such as waste bins or waste chutes.

13. A material conveying system according to claim 1, characterised in that the blower device (4) is an ejector device the outlet side of which is connected to the material conveying pipe directly or by means of a connecting channel and is arranged to blow in the circuit in the direction of the conveying air circulation.

14. A material conveying system according to claim 1, characterised in that the blower device (4) is an ejector device the actuating medium of which is gas, particularly compressed air.

15. A material conveying system according to claim 4, characterised in that the vacuum generator (3) is an ejector device the actuating medium of which is water, particularly water mist.

16. A material conveying system according to claim 4, characterised in that the vacuum generator (3) is an ejector device the actuating medium of which is gas, particularly compressed air.

17. A material conveying system according to claim 1, characterised in that in the circuit is arranged at least one valve element (69) between a blower (40) of the blower device and at least one material feed point (61, 66), which divides the circuit into the pressure side and the suction side, on which pressure side is providable overpressure, at least when the valve element (69) of the circuit is closed, and on the suction side underpressure, and that said valve (69) is arranged to open at least during the conveyance of the material.

18. A material conveying system according to claim 17, characterised in that the system comprises several circuits the air circulation of which is controllable by means of valve elements (69, 64) arranged in partial circuits.

19. A material conveying system according to claim 2, characterised in that the vacuum generator (3) is a vacuum pump.
